(19) United States
(12) Patent Application Publication
(10) Pub. No.: US 2007/0054663 A1
(43) Pub. Date: Mar. 8, 2007

(54) Method for assigning an emergency temporary directory number to a roaming mobile unit

(76) Inventors: Stuart Owen Goldman, Scottsdale, AZ (US); Richard E. Krock, Naperville, IL (US); Bernard Louis Malone III, Little Rock, AR (US); Karl F. Rauscher, Emmaus, PA (US); James Philip Runyon, Wheaton, IL (US)

Correspondence Address: Lucent Technologies Inc.;Docket Administrator, Room 3J-219, 101 Crawfords Corner Road, Holmdel, NJ, 07733-3030, US

(21) Appl. No.: 11/219,786

(22) Filed: Sep. 6, 2005

(51) Int. Cl. H04Q 7/20

(52) U.S. Cl. 455/432.1

(57) ABSTRACT

The present invention provides a method for assigning an emergency temporary directory number to a roaming mobile unit. A request is received from a mobile unit for an emergency temporary directory number. The communication system determines if the request is a valid request. If the request is a valid request, the communication system grants an emergency temporary directory number for the mobile unit. The communication system then alerts the mobile unit of the emergency temporary directory number.

### FIELD OF THE INVENTION

The present invention relates generally to communication systems, and more particularly to roaming mobile units in wireless communication systems.

### BACKGROUND OF THE INVENTION

Mobile units typically register with a home wireless communication system, which maintains records of the mobile unit for the provision of services, billing, and other purposes. Mobile units can roam, which refers to a mobile unit leaving the geographic region covered by the home wireless communication system and utilizing wireless resources of a visited wireless communication system.

When roaming, mobile units are usually able to originate and receive calls. Typically, a mobile unit is identified and provisioned with a telephone number linked to the home MSC. When the mobile unit leaves the home area and is roaming in another visited switch area, incoming calls to the mobile unit get routed to the mobile unit's home switch and are then forwarded to where the mobile unit is roaming. The calls are connected to the roaming mobile unit by assigning a temporary directory number (TDN) to a roaming mobile unit. The mobile unit is not made aware of the TDN.

However, in times of emergency, especially in the geographic region of the home communication system, roaming mobile units are often unable to receive calls due to network congestion, equipment and facilities damage, or outages in the home communication system. This can be especially frustrating for a mobile user who is not currently located in the geographic region of the home system.

One problem with the current methodology is that the current method of routing calls to a roaming mobile unit is that if the home switch is overloaded or out of service, the routing of calls to the roaming mobile unit cannot take place.

Therefore, a need exists for a method for allowing roaming mobile units to be able to place and receive calls when their home communication system is inaccessible.

### BRIEF SUMMARY OF THE INVENTION

The present invention provides an improved method for increasing the call completion rate to mobile telephone subscribers who have been temporarily relocated out of their home switch area. The mobile units are located in a visited switch area, such as during times of disaster, network damage, or overload in the home switch area. The present invention increases the call completion rate as well as relieves network traffic congestion in the affected disaster home switch area.

The present invention provides a method for successfully completing calls to mobile subscribers evacuated out of the affected home switch area and currently located in the visited switch area. In addition, the present invention minimizes overload to the network and service disruption to public as well as to government authorized callers. Embodiments of the invention provide for successfully completing call terminations directed to subscribers in the visited switch area that are originated from privileged and non-privileged users, such as the general public, yet relieves network overload in the affected area and congestion on the affected switch network in the disaster area. Call originations still preferably function normally in the visited switch area and home switch area, depending on network availability.

### BRIEF DESCRIPTION OF THE SEVERAL VIEWS OF THE DRAWINGS

FIG. 1 depicts a wireless communication system in accordance with an exemplary embodiment of the present invention.

FIG. 2 depicts a flowchart of a method for assigning an emergency temporary directory number in accordance with an exemplary embodiment of the present invention.

FIG. 3 depicts a flowchart of a method for routing a call to a mobile unit using an emergency temporary directory number in accordance with an exemplary embodiment of the present invention.

### DETAILED DESCRIPTION OF THE INVENTION

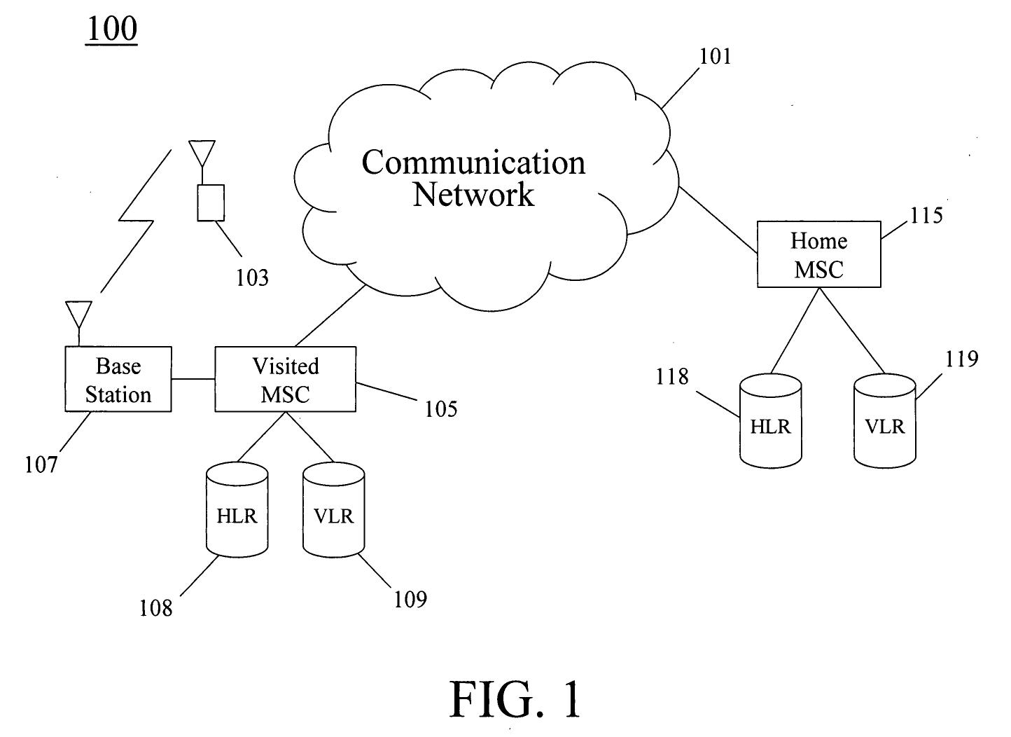

FIG. 1 depicts a communication system 100 in accordance with an exemplary embodiment of the present invention. Communication system 100 includes a communication network 101, a mobile unit 103, visited mobile switching center (MSC) 105, home MSC 115, base station 107, home location register (HLR) 108, HLR 118, visitor location register (VLR) 109, and VLR 119. Communication system 100 may include a plurality of wireless communication networks and a wireline communication network, but only communication network 101 is depicted in FIG. 1 for clarity.

Communication network 101 can include wireless and wireline service providers. Mobile unit 103 is in communication with base station 107, and can be any portable personal device that receives service from a wireless service provider.

In an exemplary embodiment, mobile unit 103 is a wireless phone. In a further exemplary embodiment, mobile unit 103 can be a Personal Digital Assistant (PDA), wireless email terminal, or any other communication device that is capable of communicating with wireless communication network 101.

Visited MSC 105 and home MSC 115 are wireless switches that provide call processing and resource management for wireless communication networks.

Each MSC is connected to a plurality of base stations, although only a single base station 107 is depicted in FIG. 1 for clarity. Visited MSC 105 and home MSC 115 process call and service requests initiated by and intended for mobile unit 103 and allocate the required transmission and signaling resources.

Base station 107 communicates with communication network 101 via visited MSC 105 and communicates over-the-air with mobile unit 103. Although only one base station and one mobile unit are depicted in FIG. 1 for clarity, it should be understood that communication network 101 typically includes a plurality of MSCs, each of which communicates with a plurality of base stations, and each base station services a plurality of wireless units. Base Station 107 is a wireless station that preferably includes connections to the controlling servers via IP (Internet Protocol) or traditional switching mechanisms.

HLR 108 and HLR 118 are databases that contain all the subscribers within the provider's home service area. When a subscriber reaches a new service area, the data in the user's HLR is requested and transferred via SS7 to a VLR in the new area.

VLR 109 and VLR 119 are databases that contain all the subscribers who are currently visiting within this service area.

Wireless communication network 101 can utilize any wireless protocol, including but not limited to analog, such as AMPS, TACS and NMT, or digital, such as GSM, TDMA, CDMA, GPRS, EDGE, IS-95, IS-95B, HDR, WCDMA, and CDMA2000.

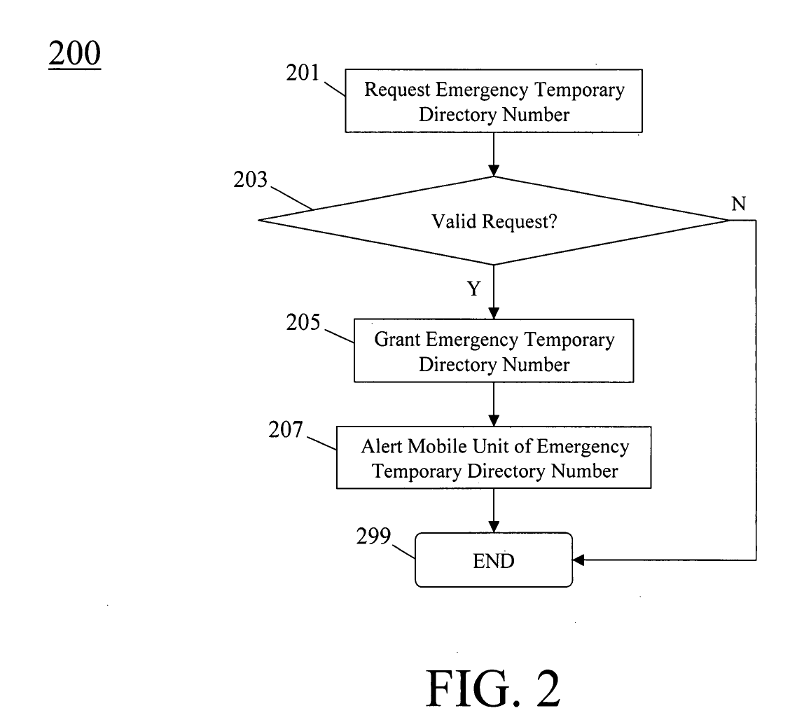

FIG. 2 depicts a flowchart 200 of a method for assigning an emergency temporary directory number in accordance with an exemplary embodiment of the present invention.

In accordance with an exemplary embodiment, mobile unit 103 requests (201) an emergency temporary telephone number. In a scenario when mobile unit 103 roams to the area covered by visited MSC 105, a user of mobile unit 103 preferably enters a star code to request an emergency temporary telephone number. In an alternate exemplary embodiment, a user of mobile unit 103 can call a service center of their service provider to verbally request an emergency temporary telephone number. In a further exemplary embodiment, a user can request an emergency temporary telephone number for mobile unit 103 by sending a request via a computer, by using email or visiting a website of the service provider.

Visited MSC 105 determines (203) if the request is a valid request. If the request is not a valid request, the process ends (299). In an exemplary embodiment, visited MSC 105 determines whether the request is valid by examining the circumstances surrounding the request and the location of mobile unit 103. For example, in one embodiment visited MSC determines that the request for an emergency temporary directory number is valid when a predetermined emergency situation exists. The predetermined emergency situation can be, for example, a natural disaster, a man-made disaster, or any other emergency situation.

Visited MSC 105 can also utilize the location of mobile unit 103 in its determination of whether the request is a valid request. For example, visited MSC 105 may limit the assignment of emergency temporary directory numbers to mobile units whose HLRs are located within a certain geographic location, such as the location affected by the emergency situation.

If the request is a valid request as determined at step 203, visited MSC 105 grants (205) the emergency temporary telephone number to mobile unit 103. Visited MSC 105 returns the emergency temporary telephone number, commonly referred to as a temporary directory number (TDN), to mobile unit 103 in a manner that alerts a user of mobile unit 103 of the new number. In an exemplary embodiment, visited MSC 105 sends the emergency temporary directory number to mobile unit 103 as readable text on the display of mobile unit 103. This allows the user to learn the new emergency temporary directory number and subsequently share the number with others.

In an exemplary embodiment, visited MSC 105 grants the emergency temporary telephone number to mobile unit 103 for a specified period of time. The time can be a default length of time or can be requested by the user. Alternately, the length of time for assignment can be based upon the number of requests received by visited MSC 105, in which scenario the length of time the after the granting of an emergency is assigned is dependent upon the number of requests received. For example, if many requests for emergency temporary telephone numbers are received, the duration of time the emergency temporary telephone number is valid can be reduced. Mobile unit 103 is able, after the granting of an emergency temporary telephone number, to originate calls, such as typical calls and emergency calls.

Visited MSC 105 alerts (207) mobile unit 103 of the emergency temporary directory number. In an exemplary embodiment, this is accomplished by displaying the emergency temporary directory number on the display of mobile unit 103.

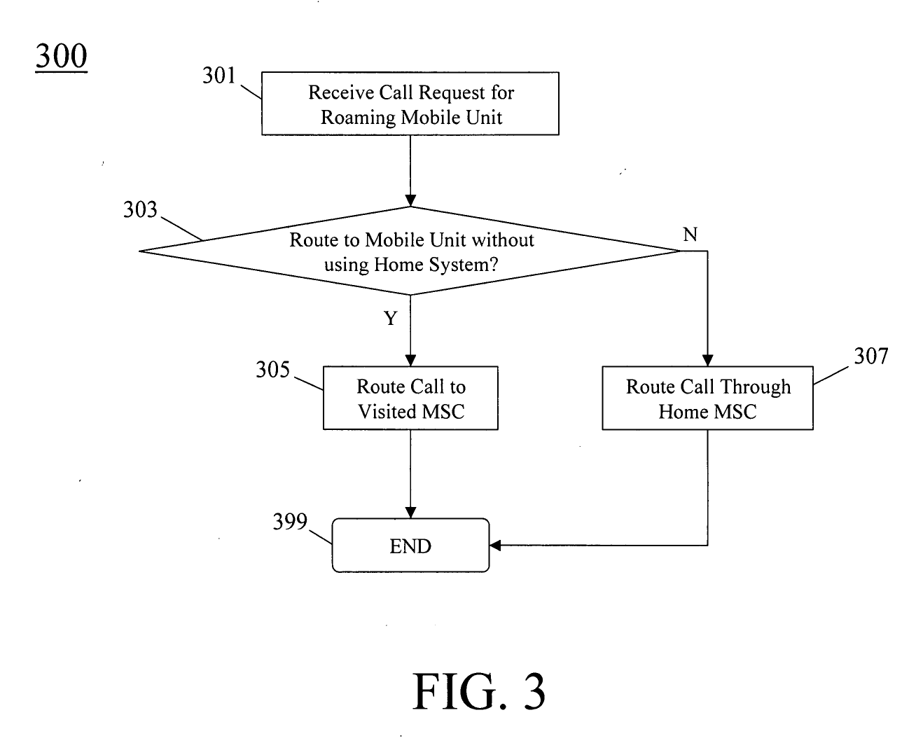

FIG. 3 depicts a flowchart 300 of a method for routing a call to a mobile unit 103 using an emergency temporary directory number in accordance with an exemplary embodiment of the present invention.

Communication system 100 receives (301) a call for mobile unit 103. In the embodiment depicted in FIG. 3, mobile unit 103 is registered with home MSC 115 as its home system, and is currently roaming and being supported by visited MSC 105. As an example, consider a call request made to mobile unit 103 utilizing the emergency temporary telephone number.

Communication system 100 determines (303) whether to route the call received for mobile unit 103 without using the home system of mobile unit 103. In an exemplary embodiment, communication system 100 makes this determination by comparing the called number with a list of emergency temporary telephone numbers. In this embodiment, visited MSC 105 knows which numbers are emergency temporary telephone numbers, and compares the received called number with the numbers in this list.

In an exemplary embodiment, communication system 100 translates the called number (TDN) and routes it toward visited MSC 105 since the TDN was taken from a pool of telephone numbers that are “owned” by MSC 105 and the PSTN translations are in place to route such numbers to MSC 105. Further, the only change necessary is that visited MSC 105 assigns and freezes the assignment of TDN to the roaming subscriber. The rest of the switches in the network preferably do not require modifications and are mot impacted.

If communication system 100 determines to route the call using the home system of mobile unit 103, communication system 100 routes (307) the call through home MSC 115. In an exemplary embodiment, this determination is made by comparing the called number to a list of reserved emergency temporary telephone numbers. If the called number is not in the list, visited MSC 105 knows that this call should be processed via normal processes, such as routing to the home MSC of the called unit if the called unit is a roaming mobile unit.

If communication system 100 determines to route the call without using the home system of mobile unit 103, communication system 100 routes (305) the call via visited MSC 105. Referring to the present example, a call placed to a roaming mobile unit utilizing an emergency temporary telephone number is received by visited MSC 105. Visited MSC 105 knows that the called number is an emergency temporary telephone number, and so does not route the call to home MSC 115. Instead, visited MSC 105 performs routing of the call to mobile unit 103, including the location, paging, and call completion to mobile unit 103.

By routing calls intended for a roaming mobile unit to a visited communication system without including the home communication system, multiple benefits are achieved. Calls have an increased likelihood of completion. Further, network congestion on the home system, which is in the midst of a disaster, is lessened, thereby reserving precious bandwidth for emergency calls and governmental usage.

By modifying the visited system to divulge the emergency temporary telephone number to the roaming mobile unit, the mobile unit can share the emergency temporary telephone number with others. The subscriber can give out the emergency temporary telephone number and expect that callers can reach him as long as he remains an active roamer in the visited area. In addition, the subscriber can expect to receive calls directed to his mobile unit when the congestion or blockage in the home network no longer prevents them, as calls to both the directory number and the emergency temporary telephone number are routed to the mobile unit.

The process then ends (399).

While this invention has been described in terms of certain examples thereof, it is not intended that it be limited to the above description, but rather only to the extent set forth in the claims that follow.

1. A method for assigning an emergency temporary directory number to a roaming mobile unit, the method comprising:
receiving a request for an emergency temporary directory number from a mobile unit;
determining if the request is a valid request;
if the request is a valid request, granting an emergency temporary directory number for the mobile unit; and
alerting the mobile unit of the emergency temporary directory number.

2. A method for assigning an emergency temporary directory number to a roaming mobile unit in accordance with claim 1, wherein the step of granting an emergency temporary directory number for the mobile unit comprises granting an emergency temporary directory number for the mobile unit for a predetermined length of time.

3. A method for assigning an emergency temporary directory number to a roaming mobile unit in accordance with claim 2, wherein the predetermined length of time is longer than a length of a call.

4. A method for assigning an emergency temporary directory number to a roaming mobile unit in accordance with claim 1, wherein the step of receiving a request for an emergency temporary directory number from a mobile unit comprises receiving a star code.

5. A method for assigning an emergency temporary directory number to a roaming mobile unit in accordance with claim 1, wherein the step of receiving a request for an emergency temporary directory number from a mobile unit comprises receiving a call at a service center.

6. A method for assigning an emergency temporary directory number to a roaming mobile unit in accordance with claim 1, wherein the step of receiving a request for an emergency temporary directory number from a mobile unit comprises receiving a request sent via a computer network.

7. A method for assigning an emergency temporary directory number to a roaming mobile unit in accordance with claim 1, wherein the step of determining if the request is a valid request comprises determining if a predetermined emergency situation exists.

8. A method for assigning an emergency temporary directory number to a roaming mobile unit in accordance with claim 1, wherein the step of determining if the request is a valid request comprises determining the location of an HLR associated with the mobile unit.

9. A method for assigning an emergency temporary directory number to a roaming mobile unit in accordance with claim 1, the method further comprising the step of limiting the number of emergency temporary directory numbers assigned.

10. A method for assigning an emergency temporary directory number to a roaming mobile unit in accordance with claim 1, wherein the step of granting an emergency temporary directory number for the mobile unit comprises granting an emergency temporary directory number only to mobile units that are located within a predetermined geographic location.

11. A method for assigning an emergency temporary directory number to a roaming mobile unit in accordance with claim 10, wherein the predetermined geographic location comprises the location affected by the emergency situation.

12. A method for assigning an emergency temporary directory number to a roaming mobile unit in accordance with claim 1, wherein the step of alerting the mobile unit of the emergency temporary directory number comprises displaying the emergency temporary directory number on the mobile unit.

13. A method for assigning an emergency temporary directory number to a roaming mobile unit in accordance with claim 1, wherein the request for an emergency temporary directory number comprises a length of time for which the emergency temporary directory number is requested.

14. A method for assigning an emergency temporary directory number to a roaming mobile unit in accordance with claim 1, wherein the step of granting an emergency temporary directory number for the mobile unit comprises granting an emergency temporary directory number for a default length of time.

15. A method for assigning an emergency temporary directory number to a roaming mobile unit in accordance with claim 1, wherein the step of granting an emergency temporary directory number for the mobile unit comprises granting an emergency temporary directory number for a length of time, and wherein the length of time is dependent upon the number of requests received.

16. A method for routing a call to a mobile unit utilizing an emergency temporary directory number, the method comprising:
receiving a call for a roaming mobile unit;
determining whether to route the call for the roaming mobile unit without using the home system of the roaming mobile unit; and
routing the call via a visited mobile switching center (MSC).

17. A method for routing a call to a mobile unit utilizing an emergency temporary directory number in accordance with claim 16, wherein the step of determining whether to route the call for the roaming mobile unit without using the home system of the roaming mobile unit comprises comparing the called number with a list of emergency temporary telephone numbers.
